(19) United States
(12) Patent Application Publication
(10) Pub. No.: US 2003/0057711 A1
(43) Pub. Date: Mar. 27, 2003

(54) Door or window stop

(76) Inventor: Giovanni Maria Laporta, Hertfordshire (GB)

Correspondence Address: HARRINGTON & SMITH, LLP, 4 RESEARCH DRIVE, SHELTON, CT, 06484-6212, US

(21) Appl. No.: 10/149,662

(22) PCT Filed: Dec. 15, 2000
(86) PCT No.: PCT/GB00/04841

(51) Int. Cl. E05C 17/04

(52) U.S. Cl. 292/8

(57) ABSTRACT

A door assembly (10) comprises a door (12) hingedly mounted on a frame (14). The assembly includes a door stop mechanism (18) acting between the rear edge (23) of the door and the adjacent frame member, for holding the door in a predetermined open position. The stop mechanism (18) comprises a hook (30) mounted on the door and engageable with a spigot (38) mounted on the frame. When the door is closed, the door stop mechanism (18) is substantially concealed from view. The spigot (38) is received in a recess (42) to act as a security dead-bolt. The door stop mechanism (18) may also be released automatically in the event of fire.

This invention relates to a stop for a door or window assembly, for holding the door or window in a predetermined open position. The invention is especially suitable for a door assembly including an automatic door closer, but the invention is not limited exclusively to this.

Many designs of door stops and window says are known. For a door, the most common form of door stop is a wedge insertable between the floor and the lower edge of the door. Such a wedge is typically unsightly in use, and is also unsightly when left on the floor when the door is closed. Another common door stop is a hook mounted on the door or on an adjacent wall by which the door can be hooked to the wall to hold the door open. The presence of a hook and a keep (e.g. an eye) on the face of the door and on the wall is also very unsightly.

The present invention has been devised bearing the above in mind.

Broadly speak, one aspect of the present invention provides a window or door assembly comprising a frame member, and a leaf hingedly moveable relative to the frame member, the leaf having a rear edge which in the closed position of the leaf lies adjacent the frame member, he assembly further comprising stop means for acting between the frame member and said rear edge of the leaf for holding the leaf in an open position, said stop means being substantially concealed from view between the rear edge and the frame member when the leaf is in a closed position.

The leaf may be the openable door or window of the assembly.

Preferably, the stop means acts between the fame member and a rear edge of the leaf adjacent to the frame member.

Preferably, the stop means comprises a member mounted on the rear edge of the leaf.

Preferably, the stop means comprises a hook and a keep mounted one on each of the frame and the leaf. Preferably, in use, the hook is capable of hooking engagement with the keep to maintain the leaf in its open position.

Preferably, the keep comprises a spigot. Preferably, in use when the leaf is closed, the spigot is received in an aperture or recess of the member on which the hook is mounted. The spigot may be retractable.

Preferably, the assembly further comprises hinge means coupling the leaf to the frame member. Preferably, the stop means comprises a member mounted on the same portion (or edge or face) of the frame member as the hinge means.

In another aspect he present invention also concerns a release control system for remotely operating at least one stop means.

Preferably the release control system is operable to release at least one stop means in response to receiving a signal from a fire alarm system.

Preferably the release control system is operable to release at least one stop means in the event that a power supply unit fails.

Optionally the release control system is operable to cause the release of individual or groups of stop means in response to user and/or automatic input signals. Preferably, such an optional embodiment release control system comprises a programmable release unit.

Other aspects of the invention are defined in the claims.

Embodiments of the invention are now described by way of example only with reference to the accompanying drawings, in which:

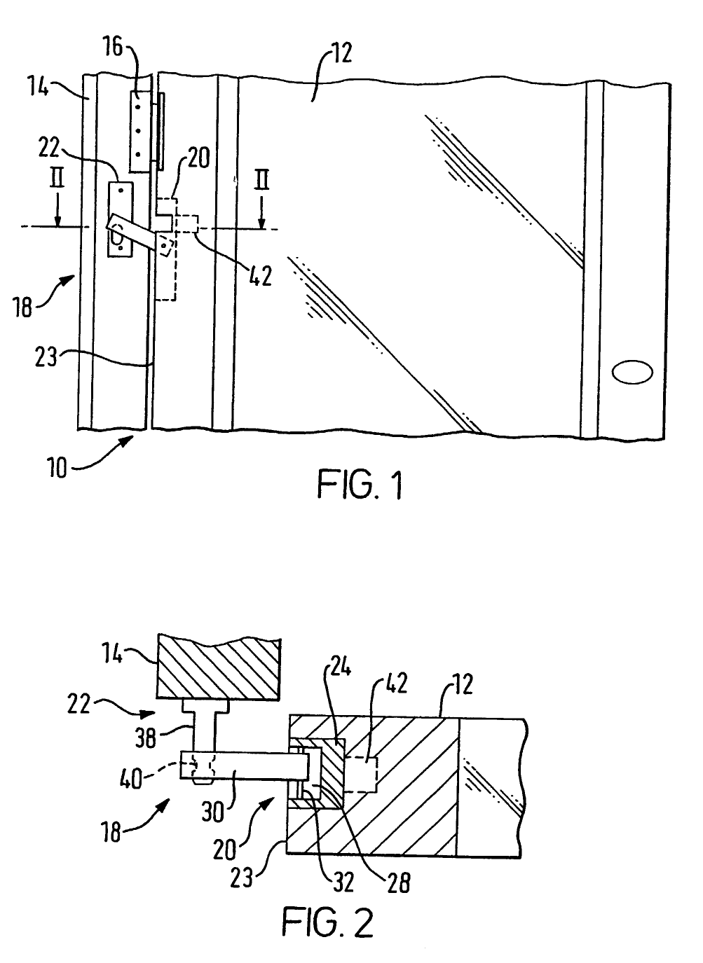

FIG. 1 is partial side view showing a door in an open position;

FIG. 2 is a schematic section along the line II-II of FIG. 1;

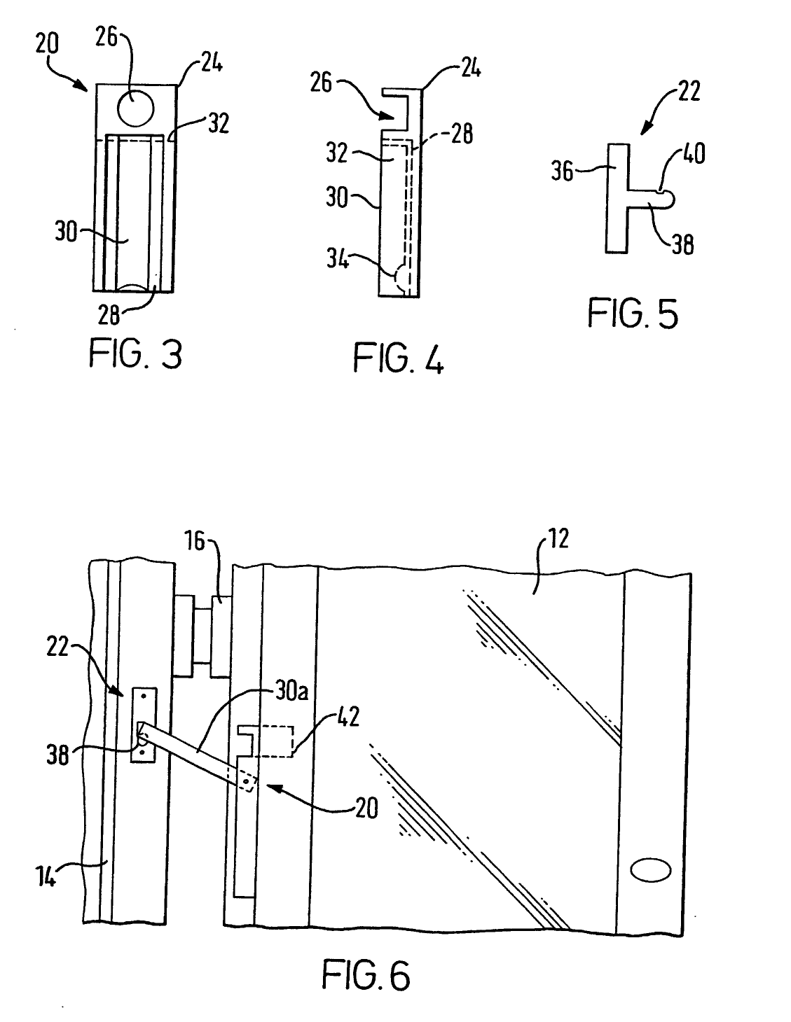

FIG. 3 is a front view of the hook unit shown in FIG. 1;

FIG. 4 is a schematic side view of the hook unit;

FIG. 5 is a side view of the keep member shown in FIG. 1;

FIG. 6 is a partial side view similar to FIG. 1 showing a modified embodiment;

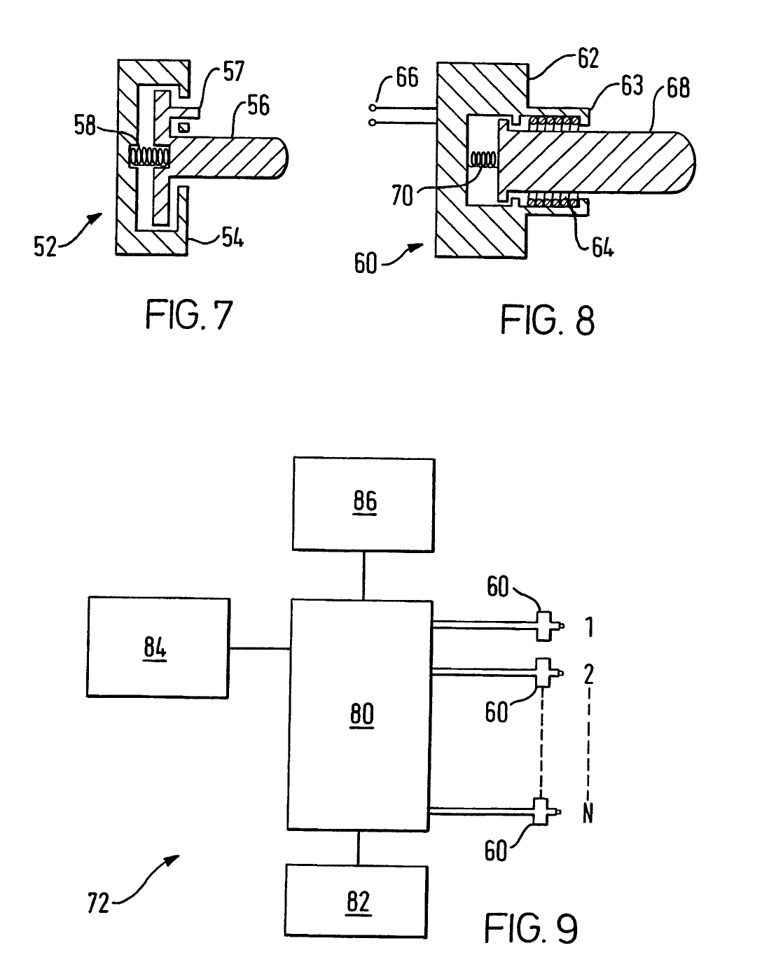

FIG. 7 shows a side view of a keep unit having a retractable spigot;

FIG. 8 shows a side view of an electrically operable keep unit having a retractable spigot; and

FIG. 9 shows a release control system incorporating a plurality of electrically operable keep units of the type shown in FIG. 8.

Referring to FIGS. 1-5, a door assembly 10 comprises a leaf in the form of a door 12, which may be solid, partly glazed, or fully glazed. The door 12 is hingedly mounted to a frame member 14 by one or more butt hinges 16. It will be appreciated that one, two or more hinges 16 may be used as desired, but for the sake of clarity only one hinge 16 is illustrated in FIG. 1.

The door assembly 10 includes a door stop 18 in the form of a hook unit 20 and a keep unit 22 with which the hook is capable of hooking engagement. In this embodiment, the hook unit 20 is mounted on the door 12, and the keep unit 22 is mounted on the frame member 14. However, it will be appreciated from the following description that in other embodiments the positions of the hook unit 20 and the keep unit 22 may be interchanged.

The hook unit 20 is mounted within a recess or cut-out on the rear edge 23 of the door. The hook unit 20 comprises a mounting surround 24 including a generally circular aperture or recess 26, and a channel-like recess 28 for receiving a hook member 30. The hook member 30 is pivotally secured at its upper, proximal end to the surround 24 by a pivot pin 32. As best seen in FIG. 3, the hook member 30 is somewhat narrower than the channel 28, to permit lateral movement of the hook member 30 within the channel. At its lower, distal end, the book member 30 has a recess 34 for hooking engagement with the keep.

The keep unit 22 comprises a base 36 from which projects a spigot 38 dimensioned to be receivable in the aperture or recess 26 of the hook unit 20. Towards its distal end, the spigot 38 has a slot 40 which can co-operate with the recess 34 of the hook member 30 to enable the hook member to hookingly engage the spigot 38.

When the door is moved to its open position (FIGS. 1 and 2), the hook member 30 can be lifted (e.g. using one's finger), and hooked onto the spigot 38 (by cooperating with the slot 40). In that condition, the hook and the keep act as a door stop to prevent the door from closing. This is especially useful if the door is likely to swing shut under gravity, or be blown shut. It is also especially useful if the door assembly includes a door closer (not shown) for automatically drawing the door closed.

To close the door, it is necessary simply to unhook the hook member 30 from the spigot 38, and allow the hook member 30 to drop back into the channel 28 of the hook unit 20. The door is then free to be closed.

As the door closes, the spigot 38 enters the aperture or recess 26 of the hook unit 20. Depending on the length of the spigot 38 and the arrangement of the door 12 and the frame 14, it might be necessary to provide a recess (shown in phantom at 42) in the door 12 to accommodate the full length of the spigot 38.

In the fully closed position of the door 12, the spigot 38 is received within the aperture or recess 26 (and the recess 42 if provided) to provide a dead-bolt security feature. In other words, even if the butt hinges 16 are destroyed or damaged by a burglar attempting to gain entry through the door, the spigot 38 engaging in the recess or aperture 26 functions to prevent the door 10 from being slid forward out of its frame.

The optimum dimensions of the hook member 30 and the spigot 38 will depend upon the specific arrangement of the door assembly, and the desired angle to which the door can be opened. It may be convenient to manufacture one or more of the hook unit 20 and keep unit 22 in different sizes, and allow a user to choose a desired size (or combination of sizes) to suit a particular installation.

As mentioned above, the hook member 30 is laterally moveable relative to the surround 24. This is provided to allow movement of the hook member 30 to accommodate a particular installation. It will be appreciated that, if desired, the hook member 30 might not be laterally movable.

FIG. 6 illustrates a second embodiment in which a longer hook member 30a is used, and the surround 24 has a longer channel 28 to accommodate the longer hook member 30a. The second embodiment functions in the same manner as the first embodiment.

FIG. 7 shows a side view of a keep unit 52 having a retractable spigot 56. The keep unit 52 may be used as an alternative to the keep unit 22 shown in the embodiments of FIGS. 1, 2, 5 and 6. The keep unit 52 comprises a retractable spigot 56, preferably smooth surfaced, mounted within a keep unit housing 54. The retractable spigot 56 can be moved in a lateral direction. The keep unit 52 further comprises a resilient biasing means 58 that biases the retractable spigot 56 in a biased position against the inner surface of the keep unit housing 54. A protruding push pin 57 extends through the outer surface of the keep unit housing 54 adjacent the retractable spigot 56.

In operation the retractable spigot 56 engages the hook member 30 to hold the door 12 in an open position. To release the door 12 a user of the system pushes the push pin 57 and the retractable spigot 56 slides laterally so as to disengage from the hook member 30. The resilient biasing means 58 then operates to return the retractable spigot 56 back to the biased position ready for the hook member 30 to be re-engaged should the door 12 require to be held open again.

FIG. 8 shows a side view of an electrically operable keep unit 60 that may be used as a replacement for any of the other keep units previously described. The electrically operable keep unit 60 comprises a retractable spigot 68 slidably mounted in a keep unit housing 62. The retractable spigot 68 is connected to the keep unit housing 62 by a resilient biasing means 70 that is held under tension. Thus the resilient biasing means 70 tends to draw the retractable spigot 68 into the keep unit housing 62 when no other forces are applied to the retractable spigot 68. The lateral movement of the retractable spigot 68 in the bore of the keep unit housing 62 is restricted in at least an outward direction by a rim or lugs formed on the retractable spigot 68 itself and the inner wall of the bore of the keep unit housing 62.

The keep unit housing 62 comprises a keep unit housing projection 63 that acts as a dead-bolt security feature which engages with the door 12 when the door 12 is in a closed position. Additionally the keep unit housing projection 63 houses a solenoid winding 64 that surrounds at least a portion of the retractable spigot 68. The retractable spigot 68 is preferably made of a magnetically active material such as, by way of non-limiting example only, iron or a permanently magnetised material.

The solenoid winding 64 may be connected via solenoid power leads 66 to an external current source so as to produce a magnetic field within the core of the solenoid winding 64. The magnetic field within the core of the solenoid winding 64 a acts upon the magnetically active retractable spigot 68 and forces the retractable spigot 68, against the action of the resilient biasing means 70, towards the outwardly extended position. In the maximum outwardly extended position the retractable spigot 68 may engage the hook member 30 to hold the door 12 open. As with the retractable spigot 56 shown in FIG. 7, the retractable spigot 68 is preferably smoothed surfaced.

If power to the solenoid winding 64 is removed, or sufficiently reduced, the resilient biasing means 70 pulls the retractable spigot 68 inwards and disengages the retractable spigot 68 from the hook member 30 if it is attached, and thereby releases the door stop allowing the door 12 to close.

Thus by controlling the power to the solenoid winding 64 doors 12 may be closed. In the event of any power failure the doors also close since insufficient current is supplied to the solenoid winding 64 to hold the retractable spigot 68 in an engaged position. This feature is advantageous since if a power failure occurs, for example during a building fire where doors and windows need to be closed to prevent the spread of fire, any doors and windows incorporating this embodiment of the present invention will close automatically.

Although one embodiment of the invention has been described in relation to the electrically operable keep unit 60, it will be understood by those skilled in the art that other electrically operable keep units may be used. For example, the solenoid may be active to retract the spigot against a resilient biassing means acting against the spigot to force it out of the keep. Additionally it is envisaged that other “fail-safe” electrically operable and/or pneumatically operable keep units may be used that act to release the door stop mechanism 18 should there be a failure of power.

FIG. 9 shows a release control system 72 incorporating a plurality N of the electrically operable keep units 60 as shown in FIG. 8. Although a plurality N of the electrically operable keep units 60 are shown, it is to be understood that N can range from unity to any integer number. The release control system 72 comprises a control unit 80 that is operable to control the supply of current to the plurality of electrically operable keep units 60. The release control system 72 is responsive to one or more signals received from a fire alarm system 84 to cut the power supplied to all of the electrically operable keep units 60 so that the doors or windows associated with respective of the electrically operable keep units 60 is cut. The fire alarm system 84 forms part of the release control system 72, but it is to be understood that in any building where a release control system 72 according to an embodiment of the present invention is to be installed, the fire alarm system 84 may already be installed and merely need to be connected to the control unit 80.

Control unit 80 is connected to a power supply unit 82 which is preferably also used to power the fire alarm system 84. The power supply unit 82 provides power for the control unit 80 and the quiescent current needed to power the electrically operable keep units 60. Should the power supply unit 82 fail, each of the N electrically operable keep units 60 releases its associated door stop mechanism 18, enabling all doors and windows to close.

Also shown in FIG. 9 is an optional programmable release unit 86. This unit can be used to program the release of either individual or groups from among the N electrically operable keep units 60. This permits programmable closing of doors and/or windows in groups or individually, and may be of assistance for security guards, automated climate control systems etc. The action to remove power from any of the N electrically operable keep units 60 may be either manually initiated by pushing a button/key etc. or automated by use of timing or other triggering signal.

In the above embodiments, the hook unit 20 and the keep unit 22 are of metal for optimum security. Keep unit 52 is also preferably formed using metal components. Keep unit housing 62 is also made of metal for optimum security. However, it will be appreciated that any suitable material may be used, such as tough plastics.

The door assembly 10 may be for a wooden door, or a metal door, or a plastics (e.g. u-PVC) door.

It will be appreciated that the preferred embodiments can provide a door stop which is simple to use, and is aesthetically discrete. In particular, when the door is closed, the door stop mechanism is substantially hidden from view. At the same time, the preferred embodiments also provide a dead-bolt security feature to improve the security of the door (or window) assembly.

It will be further appreciated that although the above embodiments employ a pivotal hook member, any form of suitable engagement means between the rear edge of the door and the frame may be used, whether it be pivoted, or slidable, or a combination of both.

The above techniques are not limited only to door assemblies, but may be used also with window assemblies. Moreover, the techniques are not limited only to assemblies using butt hinges.

It will be appreciated that the foregoing description is merely illustrative and that many modifications may be made within the scope of the invention.

The scope of the present disclosure includes any novel feature or combination of features disclosed therein either explicitly or implicitly or any generalisation thereof irrespective of whether or not it relates to the claimed invention or mitigates any or all of the problems addressed by the present invention. The applicant hereby gives notice that new claims may be formulated to such features during the prosecution of this application or of any such further application derived therefrom. In particular, with reference to the appended claims, features from dependent claims may be combined with those of the independent claims and features from respective independent claims may be combined in any appropriate manner and not merely in the specific combinations enumerated in the claims.

1. A window or door assembly comprising a frame member, and a leaf hingedly moveable relative to the frame member, the leaf having a rear edge which in the closed position of the leaf lies adjacent the frame member, the assembly further comprising stop means for acting between the frame member and said rear edge of the leaf for holding the leaf in an open position, said stop means being substantially concealed from view between the rear edge and the frame member when the leaf is in a closed position.

2. An assembly according to claim 1, wherein the stop means comprises a releasably engageable member.

3. An assembly according to claim 2, wherein the releasbly engageable member is releasable by controlling a supply of electrical or hydraulic power thereto.

4. An assembly according to claim 3, wherein the releasably engageable member automatically releases when the supply of electrical or hydraulic power is cut or substantially reduced.

5. An assembly according to any of claims 2 to 4, wherein the stop means comprises a first member on the leaf inter-engageable with a second member on the frame member.

6. An assembly according to any of claims 2 to 5, wherein the stop means comprises a member separable from a counterpart member to release the stop means.

7. An assembly according to any preceding claim, wherein the stop means comprises means for preventing the leaf from opening beyond a predetermined open position.

8. An assembly according to any preceding claim, wherein the stop means comprises a hook on one of the leaf and the frame.

9. An assembly according to claim 8, wherein the stop means further comprises a member on the other of the leaf and fame member for co-operating with the hook.

10. An assembly according to claim 8 or 9, wherein the hook is on the leaf.

11. An assembly according to any preceding claim, wherein the stop means further comprises dead-bolt means for preventing the leaf from being lifted laterally away from the frame member when the leaf is in a closed position.

12. An assembly according to claim 11, wherein the dead-bolt means comprises a spigot and an aperture in which the spigot is received, in use, when the door is in the closed position.

13. An assembly according to claim 12, wherein the spigot comprises a hook engaging slot.

14. An assembly according to claim 12, wherein the spigot is retractable.

15. An assembly according to any preceding claim, further comprising hinge means hingedly coupling the leaf to the frame member.

16. An assembly according to claim 15, where the hinge means comprises butt hinge means.

17. Stop means for use in an assembly as claimed in any preceding claim.

18. Stop means according to claim 17, wherein the stop means comprises first means for attachment to a said rear edge of a door or window, and a second means for attachment to a said frame member.

19. Stop means according to claim 18, wherein the first and second means are inter-engageable separate units.

20. A release control system for remotely opting at least one releasably engageable member constructed according to any one of claims 3 to 16.

21. A release control system according to claim 20 operable to release at least one said releasably engageable member in response to receiving a signal from a fire alarm system.

22. A release control system according to claim 20 or 21 operable to release at least one said releasably engageable member in the event that a power supply unit fails.

23. A release control system according to any one of claims 20 to 22 further comprising a programmable release unit, wherein said programmable release unit is operable to cause the release of individual or groups of said at least one releasably engageable member in response to user and/or automatic input signals.

24. A window or door assembly, or a stop means for a window or door assembly, being substantially as hereinbefore described with reference to any of FIGS. 1 to 8 of the accompanying drawings.
